(19) United States
(12) Patent Application Publication
(10) Pub. No.: US 2014/0296402 A1
(43) Pub. Date: Oct. 2, 2014

(54) COLOR INDICATING ACRYLATE RESINS AND METHODS THEREOF

(71) Applicant: 3M INNOVATIVE PROPERTIES COMPANY, St. Paul, MN (US)

(72) Inventors: Adrian T. Jung, Neuss (DE); Michael A. Kropp, Cottage Grove, MN (US)

(21) Appl. No.: 14/353,685

(22) PCT Filed: Oct. 24, 2012
(86) PCT No.: PCT/US2012/061525

§ 371 Date: Apr. 23, 2014

Related U.S. Application Data
(60) Provisional application No. 61/552,035, filed on Oct. 27, 2011.

(51) Int. Cl. C08L 33/08

(52) U.S. Cl. CPC C08L 33/08
USPC 524/159

(57) ABSTRACT

Described herein is an acrylate composition comprising: a first component comprising an amine-based curing agent and a first dye, having a first color; and a second component comprising a curable acrylate resin and a second dye, having a second color.

### TECHNICAL FIELD

A dye in at least the curing agent of an acrylate resin system is described. In another embodiment, a 2-component acrylate resin is described comprising a first component comprising an amine-based curing agent and a first dye; and a second component comprising a curable acrylate composition and a second dye.

### BACKGROUND

Acrylate adhesives can be made and/or sold as two-part (or two-component) systems comprising an adhesive part (curable acrylate resin) and an activator part (curing agent). The ratio of the curable acrylate resin and the curing agent can be formulated at various ratios. The two-part curable acrylate resin and curing agent are stored separately in individual containers, which are then mixed at the proper ratio by the end-user or they may be stored in a dual cartridge system, which dispenses an appropriate amount of curable acrylate resin and the curing agent. The curable acrylate resin and curing agent are mixed to contact and react the curing agent with the curable acrylate resin, which then cures.

Because the colors and viscosities of the curable acrylate resin and the curing agent are often similar, it may be difficult to detect the completeness of mixing. Furthermore, after mixing, the acrylate system can be handled (e.g., poured and worked) until gelation occurs. Therefore, it is also useful to know when the acrylate system has sufficiently cured. To obtain the maximum performance characteristics of the acrylate system, it is also important that the appropriate ratios of curable acrylate resin and curing agent are used and that the curable acrylate resin and curing agent are adequately mixed and cured.

Traditionally, a single dye has been added to adhesives to indicate complete mixing and/or curing. For example, U.S. Pat. No. 3,773,706 (Dunn) describes adding phenosafranin dye to a curable acrylate system to indicate cure. Great Britain Pat. No. 927,541 describes adding a triphenylmethane or anthraquinone dye to the curable acrylate resin to indicate complete mixing based on the uniformity of color, which changes color again upon gelation. U.S. Pat. No. 4,160,064 (Hodiff et al.) describes adding a coloring agent to the curable acrylate resin to impart a latently transient color to assist in determination of complete mixing, which becomes essentially colorless upon the curing of the mixture.

### SUMMARY

There is a desire to provide a 2-component acrylate resin system that would indicate to the user when multiple separate changes have occurred to the components of the acrylate resin system. In some embodiments it is desirable to know that an accurate mixing ratio of the curable acrylate resin and the amine-based curing agent was used.

In one aspect, an acrylate composition is described comprising: a first component comprising an amine-based curing agent and a first dye, having a first color; and a second component comprising a curable acrylate resin and a second dye, having a second color.

In yet another aspect, a method of indicating mixing and curing of a 2-component acrylate composition is described comprising: mixing a first component comprising an amine-based curing agent and a first dye and having a first color with a second component comprising a curable acrylate resin and a second dye and having a second color to form a third color and allowing the mixture to cure to form a fourth color, wherein each of the first, second, third, and four colors are visually different in color.

In yet another aspect, a method of indicating the correct mixing ratio of a 2-component acrylate composition is described comprising: providing first component comprising an amine-based curing agent and a first dye and having a first color and a second component comprising a curable acrylate resin and a second dye and having a second color; mixing a first certain amount of first component with a second certain amount of second component to form a third color, wherein the third color is indicative of the first certain amount and second certain amount used.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more;

“and/or” is used to indicate one or both stated cases may occur, for example A and/or B includes, (A and B) and (A or B);

“acrylate” is used to encompasses both acrylates and methacrylates; and

“corresponding other component” refers to the other component of the 2-component acrylate system, for example if the discussion is related to the first component comprising the acrylate curing agent then the “corresponding other component” is the second component comprising the curable acrylate resin, and vice versa.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 3, at least 4, at least 6, at least 8, at least 10, at least 25, at least 50, at least 100, etc.).

The present disclosure is directed to a 2-component acrylate resin system comprising a color-indicating dye, which can act as a visual indicator to the user. For example, the visual indictor may be to distinguish between the first component and the second component or between a cured composition and the second component. The visual indicator may also be used to indicate to the user when changes have occurred in the product. For example, these changes may be related to the viability of the acrylate curing agent (i.e., determining if are the amines still active enough to cure the acrylate resin) or monitoring the progression of the curing of the acrylate resin system to identify when the acrylate resin system has gelled. In one embodiment, the visual indicator may be used to indicate correct mixing ratios of the curable acrylate resin and the acrylate curing agent.

Shelf-Life Indicating Composition

In one embodiment, the present disclosure is directed to a shelf-life indicating composition comprising an acrylate curing agent and a dye. Traditionally, in an acrylate resin system using an amine-based curing agent, the acrylate curing agent is clear and colorless or opaque and colorless or variations thereof. Because the curing agent is amine-based, and depending on the molecular weight of the amines, the amines may have a tendency to degrade upon exposure to the carbon dioxide and/or water in the air, creating a blushing appearance. This blushing appearance may be visually observed as skinning or the presence of crystalline solids. If the resulting decomposition products are soluble in the aging material, the blushing may be difficult to see. Therefore, it would be advantageous to have an acrylate curing agent, which would change color upon aging. The color change may indicate to the user that the acrylate curing agent may no longer be effective or viable for curing. Thus, the present disclosure provides for a shelf-life indicating composition for the acrylate curing agent comprising an amine-based acrylate curing agent and a dye.

Although not wanting to be limited by theory, it is believed that when primary amines in the acrylate curing agent are exposed to carbon dioxide, they degrade to form an ammonium carbamate, which may alter the pH of the acrylate curing agent. Therefore, the dyes useful in a shelf-life-indicating composition, include (i) those dyes that have a color transition range which overlaps with the pH changes of the acrylate curing agent as it degrades or (ii) those dyes that react reversibly with the primary amines in the acrylate curing agent.

A pH indicating dye (also referred to herein as a halochromic dye) is an acid or a base whose protonated species have different colors. Because the pH changes as the acrylate curing agent degrades, generally they becomes more acidic, a dye should be selected such that it has a color transition range around this same pH. Because the dyes are acidic or basic, more than one species of the dye (e.g., acid, conjugate acid, base, conjugate base) may be observed depending on the pH of the system. As known by the Henderson-Hasselbach equation, pH=pKa+log(conjugate base concentration/acid concentration), when the ratio of acid to conjugate base is equal, pH=pKa. Thus, an estimate of the pH transition range of the dye may be reasoned from its pKa. The closer the color change range of the dye (e.g., estimated by the pKa) to the pH change of the degraded acrylate curing agent, the more accurate the indicating of shelf-life will be.

In the embodiment related to a pH-indicating dye, one would select a dye, which has a color indicting range within the pH change of the acrylate curing agent (for example within at least 0.5 pH units, 1 pH unit, or even 2 pH units of the pH of the acrylate curing agent when aged). For example, given an acrylate curing agent having a pH between 10 to 12 that is exposed to air, the primary amines in the acrylate curing agent react with carbon dioxide to form an ammonium carbamate, which acidifies and changes the pH of the degraded composition to perhaps, 8-10. Thus, one would select a halochromic dye, which has a color transition range (i.e., changes color) between a pH of 7 to 9 when measured in an aqueous solution. If the pH of the acrylate curing agent is more or less basic, depending on the amines chosen and the composition of the curing agent, then the halochromic dye will be selected so that the dye's indicating range is within the correct pH range as described above. Halochromic dyes that may be used include, for example: Cresol Red, Thymol Blue, and Erichrome Black T.

In the embodiment related to the dye interacting with amines in the curing agent, the dye can be selected such that the dye reversibly reacts with a primary amine In one embodiment, a dye that reversibly reacts with primary amines is selected by adding the dye to a test sample comprising primary amines and the color is noted. Typically the color observed is not that traditionally known for the dye and in one embodiment, the dye is colorless. Then carbon dioxide is added to the sample and the resulting color is noted. If the color of the initial test sample and final test sample are different, than the dye is said to have a reversible reaction with a primary amine. Dyes that reversibly react with primary amine may include, for example, cationic triarylmethane compounds, such as Patent Blue V.

In one embodiment, combinations of dyes may be added to the acrylate curing agent to indicate shelf life.

Four Color Change Composition

In another embodiment, the present disclosure is directed to a “speaking” acrylate system, wherein the user can tell based on observing the color of the composition, what composition they are looking at. For example, the user should preferably be able to distinguish the acrylate curing agent, the acrylate curable resin, the initially mixed components, and the cured mixture from each other. In this embodiment, a 2-component acrylate curing system comprises a first component comprising an acrylate curing agent and a first dye and a second component comprising a curable acrylate resin and a second dye.

In the present disclosure, the component comprising the curable acrylate resin is preferably a different color than the component comprising the acrylate curing agent. Upon mixing of the two components a third color is formed. This third color may be additive, (e.g., mixing yellow and blue yields green) or may not be additive (e.g., yellow and blue yields red). Upon curing the mixture, a fourth color is formed. Advantageously, adding a different dye to both components of the acrylate resin allows the user to identify by sight what the composition is (for example, identifying the curing agent from the curable acrylate resin from the curable mixture and the cured acrylate resin) and/or the extent of the curing reaction (for example, identifying when the curable acrylate resin has been sufficiently gelled and/or cured).

Although not wanting to be bound by theory, it is believed that there are at least three different selections of dye combinations that may be used to achieve the four different colors.

In one embodiment, the 2-component curable acrylate resin system comprises a cationic triarylmethane compound in at least one component, either the first component (i.e., the curing agent) or the second component (i.e., the curable acrylate resin). In this embodiment, the cationic triarylmethane compound may have a reversible reaction with primary amines The dye in the corresponding other component is not particularly limited. For example, the dye in the corresponding other component may also be a cationic triarylmethane dye, however, it will have a different chemical structure. In another example, a non-cationic triarylmethane dye may be added to the other component, and is not particularly limited in its color indicating range. For example one component (either the curing agent or the curable acrylate resin) comprises Patent Blue V and the other component comprises Cresol Red. It may be helpful for the user to select the dyes chosen in the first and second components such that they have different colors to enable, for example, improved visual determination of components and/or enable distinction between the various color changes.

Although not wanting to be bound by conjecture, it is believed that the triarylmethane compound may react with a component in the acrylate curing agent either reversibly or irreversibly independent of pH.

In another embodiment, the 2-component curable acrylate resin system does not comprise a triarylmethane compound. In this embodiment, it is believed that at a minimum one of the components (either the curable acrylate resin and/or the curing agent) comprises a halochromic dye, which changes color as the mixed composition cures. In other words, the halochromic dye has a color change in the pH transition range of the mixed composition as it gels or cures. During curing, the primary amines in the curing agent react to form tertiary amines and the pH of the composite becomes less basic. In one embodiment, the halochromic dye has at least two pKas, meaning it will have two color change ranges. The dye in the corresponding other component is not particularly limited in its color indicating range, however the color of the dye in the corresponding other component should preferably be a different color to enable visual distinction between the various color changes. Such halochromic dyes include, for example: Methyl Red, Methyl Orange, Cresol Red, Erichrome Black T, Thymol Blue, Bromothymol Blue, and other halochromic dyes as known in the art.

In one embodiment an amine-based curing agent comprising a first halochromic dye and having a first color transition range and a curable acrylate resin comprising a second halochromic dye and having a second color transition range may be used. Exemplary halochromic dyes may include those that have a color transition range between 7 and 10.

The selection of the dye and to which component it is added (acrylate curing agent versus the curable acrylate resin) may result in different colors for the mixing and cure. For example, dye A added to the first component and dye B added to the second component may yield a grey color upon mixing and a pink upon curing, while dye B added to the first component and dye A added to the second component may yield a yellow color upon mixing and not dramatically visually change upon curing.

Mixing Ratio

Because the present disclosure involves the mixing of two components, the curable acrylate resin and the amine-based curing agent, in another embodiment of the present disclosure, the user may be able to identify if the correct mixing ratio was used.

Typically, the ratio of the curable acrylate resin and the curing agent are selected based on the amount and type of reactive groups present in each of the components. It has been discovered that the compositions of the present disclosure may be used to indicate if a proper mixing ratio used. For example, a first certain amount of a first component comprising an amine-based curing agent and a first dye and having a first color is mixed with a second certain amount of a second component comprising a curable acrylate resin and a second dye and having a second color. When the first certain amount and the second certain amount are mixed, they form a third color and when cured, form a 4^{th} color. When an incorrect ratio is used (e.g., more and/or less of the first certain amount), the third color remains and the fourth color is not formed within an appropriate time frame (i.e., the mixture does not sufficiently cure).

Dyes

The dyes as disclosed herein are those compounds which are used to color a material by dissolving into solution. Pigments, which impart color on a material are suspended in the material, and include compounds such as carbon black, titanium dioxide, etc. For purposes of the present disclosure, pigments are not encompassed in the term “dye”, however, they may be added to the acrylate composition so long as they do not mask the color of the dye.

The dyes that may be used in the present disclosure include those with light absorption or emission in the visible color spectrum (i.e., 380-780 nm) and exhibit a color change by the change in the pH of the composition or by the formation or consumption of a reactive compound within the acrylate resin system composition.

Dyes as known in the art may be useful in the present disclosure, such as azo compounds and triarylmethane compounds. Exemplary dyes include, for example, halochromic dyes and dyes which undergo a color change when combined with reactive compounds within the acrylate resin system composition (e.g., primary amines).

A halochromic dye is a dye which changes color based on a pH change. The color change typically occurs when a substance binds to existing hydrogen or hydroxide ions in solution, which results in changes in the conjugated bond system that alters the absorption of light and results in a visible color change. Halochromic dyes may include those known in the art such as for example, Methyl Red, Cresol Red, Erichrome Black T, Thymol Blue, and Bromothymol Blue.

Dyes that are susceptible to reaction with reactive compounds within the acrylate resin system, include for example those dyes that react with a compound in either the acrylate curing agent or the curable acrylate resin, which results in changes in the conjugated bond system, which alters the absorption of light and results in a visible color change. This interaction may be irreversible or reversible, meaning the dye can be regenerated back to its original color. Such dyes may include, for example, cationic triarylmethane dyes, such as Patent Blue V, Violet Blue 6B, and Brilliant Green.

The free base or salt form of the dye may be selected to optimize the solubility of the dye in the composition of interest. In one embodiment, the form of the dye may impact the reaction rate, or the ability of the dye to indicate a color change of the composition upon, for example, mixing, curing, and/or aging. For example, in one embodiment, the dye is in its sodium salt form. In another embodiment, the dye is in its calcium salt form.

The present disclosure is directed to a visible color change in the amine-based acrylate resin system. In one embodiment of the disclosure, a visible color change may be observed between an acrylate curing agent that will adequately cure and one that that has been compromised due to ageing or a packaging flaw such as a crack or broken seal. In another embodiment of the disclosure, a visible color change may be observed between the first component (herein referred to as “the first color”), the second component (herein referred to as “the second color”), the initially mixed composition of the first and second components (herein referred to as “the third color”), and the sufficiently cured mixed composition (herein referred to as “the fourth color”). A visible color change, as referred to herein, means that the colors are sufficiently different and may be readily visible to the naked eye, or optionally a spectrophotometer or colorimeter.

In another embodiment of the present disclosure, there may be a visible color difference between an acrylate resin system that comprises a proper mixing ratio of the curable acrylate resin and the amine-based curing agent and an acrylate resin system that does not comprise a proper mixing ratio of the two components.

The difference in color may be readily observed with the naked eye by comparing one or more of the colored compositions (which also includes colorless compositions) to a reference standard color (e.g., a printed card or label, etc.) that approximates the color of the components and stages of cure (e.g., not cured versus cured).

The amount of color change exhibited by the dye in a given composition need be only that amount of change that can be accurately measured or recognized by the detection device. It is understood that an instrument such as a spectrophotometer can detect fairly small color changes reproducibly. In contrast, the human eye may not notice or “remember” small color changes, especially when lighting is variable, although the human eye can detect very small color differences when two colors are compared directly (e.g., side by side comparison using a reference standard color).

Preferably, the color change is observable without reference to a side-by-side comparison. That is, the observer can detect and recognize a difference between the colors by the unaided eye. For example between a new and an aged sample of an acrylate curing agent, or between a mixed and cured acrylate resin system. However, it is also envisioned that a reference standard may be used to facilitate the recognition of a color change. The observer can compare the composition's color with the reference color standard. This allows the observer to detect the color change more easily. The reference standard may be provided, for example, as a separate color “chip” or printed card. This chip or card may be held against the composition of interest for side-by-side comparison.

The color change disclosed herein is directed to a visible color change of the components. Color is made up of three separate attributes: hue, chroma, and lightness. Hue is the perceived object color, e.g., red, yellow, blue, green, etc. Chroma (or saturation) is the vividness of a color, e.g., dull (or grey) to vivid (or saturated). Lightness (or value) is the degree of lightness of a color, e.g., white to black. A color change as referred to herein, is a change in color visible to the naked eye. More preferably, the change in color is related to a change in hue (red to green, blue to yellow, etc.). Although these color changes can be, and are preferably, observed visually with the naked eye, an instrument may be used to more accurately determine the change in color. The color change may be quantitated using CIELAB or CIELCH color spaces. In CIELAB color space L* defines the lightness, a* defines red/green, and b* defines blue/yellow. In one embodiment, the color change observed in L*a*b* color space means ΔE*_{ab} is greater than 2, 3, 5, 6, 8, 10, 20, 30 or even 40, where ΔE*_{ab} is equal to the square root of the sum of the change in L* squared plus the change in a* squared plus the change in b* squared. In CIELCH color space L* defines the lightness, C* defines chroma, and h is the hue angle. In one embodiment, a color change in L*C*h color space means ΔH is greater than 2, 3, 5, 6, 8, 10, 20, 30, 40, or even 50, where ΔH is equal to the square root of the difference of the change in E*_{ab} squared minus the sum of the change in L* squared and the change in C* squared. In one embodiment, CMC tolerancing may be used to provide better agreement between the visual assessment and measured color difference. The CMC tolerancing system is a mathematical calculation that defines an ellipsoid around the standard color, which varies in shape to better match color changes that are visual to a human eye. For example, the human eye is more sensitive to changes in chroma than in lightness, which is taken into account in the CMC tolerancing.

The dye in the first and/or second component should be present in an amount sufficient to provide a visual indication of the change. The amount of dye needed will depend on a number of factors including the natural color of the composition and the desired amount of color change (e.g., less color change may be needed when the detector is more sensitive, more color change may be needed when the color change is poorly visible). In addition, the amount of dye needed will also depend on the dye's tinctorial strength. The dye should have enough tinctorial strength to color the composition effectively and provide for the necessary color change. A common measure of tinctorial strength is the dye's “extinction coefficient.” In general, higher extinction coefficient dyes are preferred due to their greater contribution per molecule to color. Lower extinction coefficient dyes, while not preferred, may nevertheless be employed, usually at somewhat higher concentration. For the present disclosure, the amount of dye preferably should be a sufficient amount such that the dye's contribution to the composition's color can be easily observed using the naked eye. The composition may comprise between 0.0001%, 0.001%, 0.005%, 0.01%, 0.05%, 0.1% or even 0.5% to 0.75%, 1.0%, 1.5%, 2.0%, 3.0%, 4.0%, 4.5% or even 5.0% based on the total weight of the composition (e.g., in the case of the shelf-life indicating composition, the total weight is the weight of the acrylate curing agent and in the case of the four color change composition, the total weight is the total weight of acrylate resin system).

Those skilled in the art of dye chemistry will understand that for dyes with a lower molar extinction coefficient correspondingly greater amounts of dye will be required to achieve the same color intensity as a dye with a higher molar extinction coefficient.

In addition, the dye (which may be a liquid or solid) should be soluble in the composition being colored. A “soluble” dye, as used herein, is a dye that when mixed with the initial or uncured composition (including any optional solubilizing agents, e.g., cosolvents or surfactants, that are present in the composition) under the desired conditions of use, dissolves to form a homogeneous colored composition. Such conditions of use include temperature (e.g., over the temperature range encountered during use and cure of the composition), time (e.g., the amount of time the composition is in the uncured state), and concentration (e.g., the concentration of cure-indicating dye in the composition.

The dye-containing composition may optionally comprise one or more suitable cosolvents. The cosolvents may be employed to facilitate the dissolution of the dye and/or other adjuvants in the composition, to facilitate uniform mixing of the reactants, or to adjust the composition's viscosity or flow. Suitable cosolvents for use with the curable acrylate resin and/or the acrylate curing agent include aromatic hydrocarbons, such as xylene and toluene, aliphatic hydrocarbons, such as hexane and mineral spirits, and halogenated hydrocarbons, such as chlorobenzene and trichloroethane. It is desirable that the solvent be transmissive to visible light. In one embodiment, the composition contains less than about 70, 40, or even 10 weight percent cosolvent.

In one embodiment, the dyes are soluble in the composition of interest without the presence of a cosolvent.

Acrylate Curing Agent

Curing agents suitable in the present disclosure are primary or secondary linear or branched long-chain amines, with primary amines being preferred. In one embodiment, the curing agent has a molecular weight of greater than about 150 g/mol, for example between 200 and 700 g/mol. Typically, the curing agent has a molecular weight of less than 3000 g/mol.

Examples of suitable curing agent include those according to the general formula

R¹R²N—R³—NR⁴H (I)

wherein R¹, R² and R⁴ represent, independently from each other, hydrogen, a linear or branched alkyl, or a linear or branched polyoxyalkyl moiety.

The residues R¹, R², R⁴ may contain a hydrocarbon containing about 1 to 25 carbon atoms or a polyether containing from 3 to 25 carbon atoms. Preferably, one, more preferably two and most preferably all residues R¹, R² and R⁴ are hydrogen.

R³ represents a linear or branched alkylene, alkylamine, polyaminoalkylene, polyamidoalkylene, alkylether, or polyoxyalkylene residue having at least 5 carbon atoms.

Preferably, R³ is a polyether and the curing agent is a polyetheramine or polyetherdiamine including those polyetheramines that can be derived from polypropyleneoxide or polyethylenoxide. R³ may also be a polyamidoamine or a polyamidodiamine including those that can be derived by reacting a dimer or trimer carboxylic acid with a polyetheramine.

Suitable polyetheramines that can be used include, but are not limited to, those corresponding to the general formula

H₂N—C₃H₆—O—[C₂H₄—O—]nC₃H₆—NH₂, (II)

H₂N—C₃H₆—O—[C₃H₆—O—]nC₃H₆—NH₂ (III)

H₂N—C(CH₃)H—CH₂[O—CH₂—C(CH₃)H]n—O—CH₂—CH(CH₃)—NH₂ (IV)

with n being within the range of 1 and 34, such as for example 1, 2, 3, 4, 5, or between 1 and 2 (such as for example 1.5 or 1.7), between 2 and 3 (such as for example 2.5 or 2.7), between 3 and 4 (e.g. 3.5 or 3.7), between 4 and 5 (e.g. 4.5 or 4.7), or n being 31, 32, 33 or between 31 and 33.

Suitable amines are available under the trade designation “PC AMINE DA” from Nitroil, Germany or under the trade designation “JEFFAMINE” from Huntsman, Belgium. A particular preferred curing agent is 4,7,10-trioxatridecane-1,13-diamine (TTD). TTD is commercially available, for example, from BASF or Nitroil.

Combinations of curing agents, for example, a combination of two or more polyetherdiamines are also suitable. In one embodiment, the curing agent comprises at least one curing agent according to formula (II), (III) or (IV).

The one or more curing agents in the curing agent composition may be present in an amount from about 10 to about 50% wt, preferably from about 15 to about 45% wt. In some embodiments, the curing agents may be present in the total composition at greater than their stoichiometric ratio, i.e., the curing agents may be present in a molar ratio of amine active hydrogens to acrylate functionalities of >1.0 (typically from 1.10 to 1.30).

In further embodiments, there are provided compositions that comprise in addition to the curing agent one or more metal salt catalysts for accelerating the curing. Suitable catalysts are those known in the art and include group I metals, group II metals or lanthanoid salts wherein the anion is selected from nitrates, iodides, thiocyanates, triflates, alkoxides, perchlorates, sulfonates, and their hydrates.

For most applications, the catalyst will be used from about 0.05 to less than 15% wt based on the total weight of the acrylate resin system.

Curable Acrylate Resin

The curable acrylate resins useful in the compositions of the present disclosure include those derived from acrylates as are known in the art. As used herein acrylates, include both acryl and methacryl functional groups. Methacrylates may be used to control cure speed, however preferably the composition comprises primarily acryl functional groups.

The term “polyfunctional” in the context of a “polyfunctional acrylate resin” refers to a polyacrylate resin monomer or a monomer containing more than one acrylate functionality, although other functionality can be present. The curable polyfunctional acrylate resins useful in the compositions of the present disclosure include those derived from, for example, reaction of various polyols with stoichiometric, or less, amounts of acrylic or methacrylic acid as is well known in the art. Suitable polyols include, for example, ethylene glycol, hexanediol, triethylene glycol, trimethylol propane, ethoxylated trimethylol propane, glycerol, pentaerythritol, and neopentylglycol.

In one embodiment, the curable acrylate resins may comprise an acid component, which is able to undergo a Michael Addition (one example being the reaction between an amine and an activated carbon double-bond). Such acid components can adjust the pH to a desired value and also aid in improving the adhesion of the composition. Acidic components include, for example, acrylic and methacrylic acid.

In one embodiment a polyfunctional acrylate is used. Polyfunctional acrylates can be a monomer (i.e., a small (low-molecular-weight) molecule with an inherent capability of forming chemical bonds with the same or other monomers in such manner that long chains (polymeric chains or macromolecules) are formed or an oligomer (i.e., a polymer molecule having 2 to 10 repeating units (for example, dimer, trimer, tetramer, and so forth) having an inherent capability of forming chemical bonds with the same or other oligomers in such manner that longer polymeric chains can be formed therefrom. Mixtures of monomers and oligomers also could be used as the polyfunctional acrylate component. It is preferred that the polyfunctional acrylate component be monomeric.

Representative polyfunctional acrylate monomers include, by way of example and not limitation: ethylene glycol diacrylate, ethylene glycol dimethacrylate, hexanediol diacrylate, triethylene glycol diacrylate, trimethylolpropane triacrylate, ethoxylated trimethylolpropane triacrylate, glycerol triacrylate, pentaerthyitol triacrylate, pentaerythritol trimethacrylate, pentaerythritol tetraacrylate, pentaerythritol tetramethacrylate, and neopentylglycol diacrylate. Mixtures and combinations of different types of such polyfunctional acrylates also may be used.

Useful commercially available polyfunctional acrylates include trimethylolpropane triacrylate having the trade designation “SR351,” ethoxylated trimethylolpropane triacrylate having the trade designation “SR454,” pentaerythritol tetraacrylate having the trade designation “SR295,” and neopentylglycol diacrylate having the trade designation “SR247,” all available from Sartomer Co., Exton, Pa.

The polyfunctional acrylate monomers cure into a network due to the multiple acrylate functionalities available on each monomer. If there is insufficient acrylate functionality, a linear, non-networked molecule will result upon cure of the material. Polyfunctional acrylates having two or more acrylate groups may be preferred to encourage and promote the desired polymeric network formation.

To achieve sufficient properties, such as curing rate and/or adhesion, it is preferable that acrylates having at least 3 acrylate groups and/or a curing agent having at least 3 primary amines is used.

In one embodiment, additional monofunctional monomers may be used, including the acidic monomers described above. Exemplary monomers include those of the formulas: CH₂═CH—COOR and CH₂═C(CH₃)—COOR¹, where R is CₙHₙ₊₁ and wherein n at least 0, 1, 2, 3, 4, 5, or even at least 10 or more, and R¹ is CₙHₙ₊₁ and wherein n at least 0, 1, 2, 3, 4, 5, or even at least 10 or more. Additional exemplary monomers include: hexyl acrylate, 2-ethylhexyl acrylate, lauryl acrylate, ethyl acrylate, dicyclopentadienyloxyethyl methacrylate, cyclohexylmethacrylate, lauryl methacrylate, tetrahydrofurfuryl acrylate, phenoxyethyl acrylate, and the like.

Generally, both low molecular weight monomers, for example, methyl acrylate and methyl methacrylate are commonly used along with higher molecular weight monomers where n is greater than 2, commonly n is 10-18, and more commonly n is 12-16. Exemplary commercial higher molecular weight monomers include SR 313B, which is a mixture of C12, C14, and C16 methacrylates available from Sartomer Company, Inc. of Exton, Pa.; and that sold under the trade designation “AGEFLEX FM246”, which is a mixture of C12, C14, and C16 methacrylates available from Ciba Specialty Chemicals of Basel, Switzerland.

Exemplary acrylic monomers include: 2-ethylhexyl methacrylate hexyl methacrylate vinyl group, methyl methacrylate, ethyl methacrylate, butyl methacrylate, methyl acrylate, butyl acrylate, cyclohexyl acrylate, hexyl acrylate, 2-ethylhexyl acrylate, lauryl acrylate, ethyl acrylate, diethylene glycol dimethacrylate, dicyclopentadienyloxyethyl methacrylate, cyclohexylmethacrylate, lauryl methacrylate, tetrahydrofurfuryl methacrylate, methacrylic acid, and acrylic acid.

Additives

In addition to the dyes, the curing agent component and/or the curable acrylate resin component may comprise fillers such as toughening agents, reactive diluents, rheology controlling agents, adhesion enhancers and/or promoters, pigments, flame retardants, anti-oxidants, and/or UV-protecting agents. The optimum amounts of fillers depend on the amounts and characteristics of the other ingredients present in the curing agent and/or the curable acrylate resin or in the total curable composition. Optimum amounts can be identified through routine experiments for example, by measuring the Brookfield viscosity of the composition, or the characteristics of the cured composition.

Exemplary toughening agents include polychloroprene (such as Neoprene), copolymers of butadiene with styrene, and other copolymers of acrylonitrile, acrylates, methacrylates and the like.

Reactive diluents may be added to control the flow characteristics of the adhesive composition, such as those disclosed in U.S. Prov. Appl. No. 61/359,474 (Jung), herein incorporated by reference in its entirety.

Typical examples of rheology controlling agents include, but are not limited to, silica-gels, Ca-silicates, phosphates, molybdates, fumed silica, clays such as bentonite or wollastonite, organo-clays, aluminium-trihydrates, hollow-glass-microspheres; hollow-polymeric microspheres and calcium-carbonate. Commercially available rheology controlling agents, include, for example: “SHIELDEX AC5” (Grace Davison, Columbia, Md.), a synthetic amorphous silica, calcium hydroxide mixture; CAB-O-SIL TS 720 (Cabot GmbH, Hanau, Germany), hydrophobic fumed silica-treated with polydimethyl-siloxane-polymer; glass-beads class IV (250-300 microns), Micro-billes de verre 180/300 (CVP S.A., France) ; glass bubbles K37 (3M Deutschland GmbH, Neuss, Germany), MINSIL SF 20 (Minco Inc., 510 Midway, Tenn.), amorphous silica; APYRAL 24 ESF (Nabaltec GmbH, Schwandorf, Germany) amorphous, fumed silica; ΔEROSIL™ R.202 (Degussa, Germany), and treated fumed silica.

Compounds may be added to enhance and/or promote adhesion. Optionally, one or more acid components, which are able to undergo a Michael Addition, such as ethylenically unsaturated carboxylic acids, may be employed in the adhesive formulation to enhance adhesion to substrates or components, and to increase heat resistance. Exemplary carboxylic acids include methacrylic acid, maleic acid, acrylic acid, crotonic acid, fumaric acid, malonic acid, and so on. Additional examples include acetylene dicarboxylic acid, dibromo maleic citranoic acid, mesaconic acid, and oxalic acid. By adding one or more such carboxylic acids, particularly strong organic carboxylic acids, to the present acrylate-based adhesive compositions, the bonding characteristics of the adhesive compositions to the subsequently bonded structural components and parts are improved.

Adhesion promoters other than unsaturated carboxylic acids such as phosphates may be used, including methacryloxyethyl acid phosphate and acryloxyethyl acid phosphate, and so on. These compounds improve adhesion to various bare metal substrates. In one embodiment, about 0.5 wt % to about 5 wt % of an adhesion promoter is used based on the adhesive part.

Other adhesion promoters for example, silane-containing compounds may or may not be included.

In one embodiment, metallic di(meth)acrylates may be used to improve adhesion of acrylate resin to metal substrates.

In one embodiment, additional compounds are added to either the curable acrylate resin or the acrylate curing agent to prevent premature curing. These compounds include for example, chelating agents such as hexadentates, bidentates, tridentates, and the like; and inhibitors and retardants such as butylated hydroxytoluene (BHT), quinones (e.g., hydroquinone, benzoquinone, etc.), nitrobenzene, 1,3,5-trinitrobenzene, sulfur, aniline, phenol, chloroanil, and the like.

Examples of flame retardants include, but are not limited to, aluminium trihydrates, or magnesium hydroxides, red phosphorous and ammonium polyphospate. Examples of commercially available products include Portaflame SG40 (Ankerpoort, the Netherlands), aluminium trihydrate, acrylatesilane-functionalized (2 wt %) aluminium trihydrate.

Pigments may include inorganic or organic pigments. Typical examples include but are not limited to ferric oxide, brick dust, carbon black, titanium oxide and the like. Pigments may be present so long as the pigment does not mask the color changes of the present disclosure as described herein.

Application and Mixing

The dyes may be incorporated into the curable acrylate resin and/or the curing agent by intensive stirring or grinding of the components with the dye powder or by mixing the individual components with a solution of the dye. For example with a solution in a solvent incorporated into the components. Suitable solvents include: ketones, such as methyl ethyl ketone, polyethylene glycol, and polycarbonate. Such solutions should be concentrated as much as possible, for example 2 to 20% strength.

The curing agent and the curable acrylate resin compositions may be contained in cartridges and converted into a curable composition for example by extruding the two components simultaneously through a shared nozzle. In another embodiment, the curing agent and the curable acrylate resin compositions may be contained in separate containers and converted into a curable composition for example by individually measuring out each of the components and mixing them together.

The application of the curing agent and the curable acrylate resin compositions or curable composition to the desired surface can be carried out using, for example, manual applicators or air-powered applicators. Manual and air-powered applicators are available, for example, as EPX manual or EPX air-powered applicators from 3M Company, St. Paul, Minn., USA.

Curing may be carried out a room temperature. Heat may be optionally applied, but application of heat is not necessary.

The mixing of the curable acrylate resin with the curing agent takes place in a known manner. Ratios of the curable acrylate resin to the curing agent are typically from 4:1 to 1:4 based on volume or weight, preferably, 2:1, most preferably 1:1. The mixture can be accomplished either manually or mechanically with a whisk or a mixing screw. The user may want to mix the curable acrylate resin with the curing agent so that the mixture can be visual evaluated for completeness of mixing and/or curing.

The curing of the curable acrylate resin with the curing agent occurs by normal means as is known in the art. For example, the compound can be cured at room temperature over a period of from 0.5 to 10 hours, or at elevated temperatures such as between 30 to 170° C. over a period of 5 to 60 minutes.

The addition of the dyes to the 2-component acrylate resin system should not alter the normally employed curing procedures or reaction components.

Non-limiting embodiments of the present disclosure include:

Item 1. An acrylate composition comprising: a first component comprising an amine-based curing agent and a first dye, wherein the first component has a first color; and a second component comprising a curable acrylate resin and a second dye, wherein the second component has a second color.

Item 2. The composition according to item 1, wherein the first color and the second color are visually different.

Item 3. The composition according to any one of the proceeding items, wherein the first component and the second component are mixed to form a mixture and wherein the mixture has a third color.

Item 4. The composition according to item 3, wherein the third color is visually different from the first color and the second color.

Item 5. The composition according to item 4, wherein the third color is visually not an additive of the first color and the second color.

Item 6. The composition according to any one of items 3-5, wherein the mixture is cured and the cured mixture has a fourth color.

Item 7. The composition according to item 6, wherein the fourth color is visually different in color from the first color, the second color, and the third color.

Item 8. The composition according to item 7, wherein the difference in color has a ΔH of at least 1 when calculated in L*C*h color space.

Item 9. The composition according to any one of items 7-8, wherein the difference in color has a ΔE*_{ab} of at least 1 when calculated in L*a*b* color space.

Item 10. The composition according to any one of the previous items wherein the first dye is at least one of a triarylmethane compound, an azo compound, and combinations thereof.

Item 11. The composition according to any one of the previous items wherein the second dye is at least one of a triarylmethane compound, an azo compound, and combinations thereof.

Item 12. The composition according to any one of the previous items wherein at least one of the first dye and the second dye is a cationic triarylmethane compound.

Item 13. The composition according to item 12, wherein the cationic triarylmethane compound reversibly reacts with a primary amine

Item 14. The composition according to any one of items 1-11, wherein at least one of the first dye and the second dye is a halochromic dye, which comprises a color transition range from pH 7-9 in an aqueous solution.

Item 15. The composition according to any one of items 1-11, wherein the first dye is Patent Blue V.

Item 16. The composition according to any one of items 1-11, wherein the second dye is Cresol Red.

Item 17. The composition according to any one of items 1-11, wherein the second dye is Erichrome Black T.

Item 18. The composition according to any items 1-11, wherein the first dye is Bromothymol Blue.

Item 19. The composition according to any items 1-11 or item 15, wherein the second dye is Methyl Red.

Item 20. The composition according to any one of the previous items, wherein the amine-based curing agent is selected from the formula:

R¹R²N—R³—NR⁴H (I)

wherein R¹, R² and R⁴ represent, independently from each other, hydrogen, a linear or branched alkyl or a linear or branched polyoxyalkyl moiety, and R³ is a linear or branched alkylene, alkylamine, polyaminoalkylene, polyamidoalkylene, alkylether, or polyoxyalkylene residue.

Item 21. The composition according to any one of the previous items, wherein the curable acrylate resin comprises a pentaerthyitol triacrylate, a pentaerythritol tetraacrylate, a ethoxylated trimethylolpropane triacrylate, and combinations thereof.

Item 22. A 2-component acrylate comprising: a first component comprising an amine-based curing agent and a first halochromic dye, wherein the first halochromic dye has a first color transition range and a second component comprising a curable acrylate resin comprising a second halochromic dye and having a second color transition range.

Item 23. The 2-component acrylate according to item 22, wherein at least one of the first color transition range or the second color transition range is between 7-9 when measured in an aqueous solution.

Item 24. The 2-component acrylate according to any one of items 22-23 wherein at least one of the first halochromic dye and the second halochromic dye is at least one of Cresol Red, Erichrome Black T, Thymol Blue, Bromothymol Blue, and combinations thereof.

Item 25. A method of indicating mixing and curing of a 2-component acrylate composition comprising: mixing a first component comprising an amine-based curing agent and a first dye and having a first color with a second component comprising a curable acrylate resin and a second dye and having a second color to form a third color and allowing the mixture to cure to form a fourth color, wherein each of the first, second, third, and four colors are visually different in color.

Item 26. The method according to item 25, wherein the difference in color has a ΔH of at least 1 when calculated in L*C*h color space.

Item 27. The method according to item 25, wherein the difference in color has a ΔE of at least 1 when calculated in L*a*b* color space.

Item 28. The method according to any one items 25-27, wherein the amine-based curing agent is selected from the formula:

R¹R²N—R³—NR⁴H (I)

wherein R¹, R² and R⁴ represent, independently from each other, hydrogen, a linear or branched alkyl or a linear or branched polyoxyalkyl moiety and R³ is a linear or branched alkylene, alkylamine, polyaminoalkylene, polyamidoalkylene, alkylether, or polyoxyalkylene residue.

Item 29. The method according to any one items 25-28, wherein the curable acrylate resin comprises a pentaerthyitol triacrylate, a pentaerythritol tetraacrylate, a ethoxylated trimethylolpropane triacrylate, and combinations thereof.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

TABLE 1
Materials

| Name | Source |
|---|---|
| Curable | Aromatic acrylate resin sold under the trade designation |
| Resin 1 | “MCURE 100” available from Sartomer Europe, Paris |
| | La Defense Cedex, France. |
| TTD | 4,7,10-Trioxatridecane-1,13-diamine available from |
| | BASF, Ludwigshafen, Germany |
| Curable | Aliphatic acrylate resin sold under the trade designation |
| Resin 2 | “MCURE 201” available from Sartomer Europe, Paris |
| | La Defense Cedex, France. |
| TETA | Triethylenetetramine available from Huntsman BVBA, |
| | Everberg, Belgium. |
| Monomer | Pentaerythritol triacrylate sold under the trade designation |
| | “SR444D” by Startomer Co. Inc., Exton, PA. |
| Acrylic acid | Acrylic acid, glacial, available from BASF, Ludwigshafen, |
| | Germany |
| Silica 1 | hydrophobic fumed silica, treated with polydimethyl |
| | siloxanes sold under the trade designation “AEROSIL |
| | R202” from Evonik Degussa GmbH, Hanau, Germany |
| Silica 2 | fumed silica sold under the trade designation “AEROSIL |
| | 200” from Evonik Degussa GmbH, Hanau, Germany |
| Dye 1 | Methyl Red, 2-(4-dimethylaminophenyl)diazenylbenzoic |
| | acid, sodium salt, available from Merck KGaA, |
| | Darmstadt, Germany |
| Dye 2 | Patent Blue V (FBL5), calcium 4-[[4-(diethyl-amino)phenyl]- |
| | (4-diethylazaniumylidenecyclohexa-2,5-dien-1-ylidene) |
| | methyl]-6-hydroxybenzene-1,3-disulfonate available from |
| | Ciba Specialty Chemicals, Basel, Switzerland. |

Preparation of Component A (amine-based curing agent): 6.58 g TETA, 13.15 g of TTD were mixed with 1.32 g (grams) of Silica 2 using a mixer (sold under the trade designation “DAC 150 FV SPEEDMIXER” by Hauschild Engineering, Hamm, Germany) at 3500 rpm for 3 minutes. Subsequently, 0.05 g of Dye 2 was added and the mixture was again mixed using the mixer at 3500 rpm (revolutions per minute) for 1 minute.

Preparation of Component B (curable acrylate resin): 36.52 g of Curable Resin 1, 35.62 g of Curable Resin 2, 7.30 g Monomer, and 7.30 g Acrylic Acid was mixed with 1.83 g of Silica 1 using a mixer (sold under the trade designation “DAC 150 FV SPEEDMIXER” by Hauschild Engineering, Hamm, Germany) at 3500 rpm for 3 minutes. Subsequently, 0.16 g of Dye 1 was added and the mixture was again mixed using the mixer at 3500 rpm for 1 minute.

### Example 1

Components A and B were placed on a white, non-printed playing card in a weight ratio 1 part Component A to 1 part Component B. The two parts were mixed using a spatula and allowed to stand at ambient conditions for at least 24 hours. Visual assessment of the mixed sample was done initially and again after about 24 hours. Shown in Table 2 are the colors of Components A and B containing each dye, the color immediately following mixing and the color of the mixed sample approximately 24 hours after mixing.

TABLE 2

| | Color |
|---|---|
| Component A | colorless |
| Component B | red |
| Immediately following | yellow |
| mixing of components | |
| 24 hours after mixing | yellow |
| of components | |

### Example 2

Components A and B were placed on a white, non-printed playing card and mixed at two different ratios. Shown in Table 3 is the color during mixing and the color after 24 hours. It was noted that the color change from yellow to green in these samples occurred quickly after mixing, along with gellation of the composition, indicating a fast reaction between the curing agent and the curable acrylate resin.

TABLE 3

| Parts | Parts | Color during | Color 24 hours |
|---|---|---|---|
| Component A | Component B | mixing | after mixing |
| 1 | 2 | yellow | green |
| 1 | 4 | yellow | green |

All references cited herein are expressly incorporated herein by reference in their entirety into this disclosure. Foreseeable modifications and alterations of this invention will be apparent to those skilled in the art without departing from the scope and spirit of this invention. This invention should not be restricted to the embodiments that are set forth in this application for illustrative purposes. To the extent that there is a conflict or discrepancy between this specification and the disclosure in any document incorporated by reference herein, this specification will control.

1. An acrylate composition comprising: a first component comprising an amine-based curing agent and a first dye, wherein the first component has a first color; and a second component comprising a curable acrylate resin and a second dye, wherein the second component has a second color.

2. The composition according to claim 1, wherein the first color and the second color are visually different.

3. The composition according to claim 1, wherein the first component and the second component are mixed to form a mixture and wherein the mixture has a third color, wherein the third color is visually different from the first color and the second color.

4. The composition according to claim 3, wherein the mixture is cured and the cured mixture has a fourth color, wherein the fourth color is visually different in color from the first color, the second color, and the third color.

5. The composition according to claim 1 wherein the first dye is at least one of a triarylmethane compound, an azo compound, and combinations thereof.

6. The composition according to claim 1 wherein the second dye is at least one of a triarylmethane compound, an azo compound, and combinations thereof.

7. The composition according to claim 1 wherein at least one of the first dye and the second dye is a cationic triarylmethane compound.

8. The composition according to claim 7, wherein the cationic triarylmethane compound reversibly reacts with a primary amine.

9. The composition according to claim 1, wherein at least one of the first dye and the second dye is a halochromic dye, which comprises a color transition range from pH 7-9 in an aqueous solution.

10. The composition according to claim 1, wherein the first dye is selected from at least one of Patent Blue V and Bromothymol Blue.

11. The composition according to claim 1, wherein the second dye is selected from at least one of Methyl Red, Cresol Red, and Erichrome Black T.

12. The composition according to claim 1, wherein the amine-based curing agent is selected from the formula:
R¹R²N—R³—NR⁴H (I)
wherein R¹, R² and R⁴ represent, independently from each other, hydrogen, a linear or branched alkyl or a linear or branched polyoxyalkyl moiety, and R³ is a linear or branched alkylene, alkylamine, polyaminoalkylene, polyamidoalkylene, alkylether, or polyoxyalkylene residue.

13. The composition according to claim 12, wherein the curable acrylate resin comprises a pentaerthyitol triacrylate, a pentaerythritol tetraacrylate, a ethoxylated trimethylolpropane triacrylate, and combinations thereof.

14. A 2-component acrylate comprising:
a first component comprising an amine-based curing agent and a first halochromic dye, wherein the first halochromic dye has a first color transition range and a second component comprising a curable acrylate resin comprising a second halochromic dye and having a second color transition range.

15. A method of indicating mixing and curing of a 2-component acrylate composition comprising: mixing a first component comprising an amine-based curing agent and a first dye and having a first color with a second component comprising a curable acrylate resin and a second dye and having a second color to form a third color and allowing the mixture to cure to form a fourth color, wherein each of the first, second, third, and four colors are visually different in color.

16. The composition according to claim 3, wherein the third color is visually not an additive of the first color and the second color.

17. The composition according to claim 1, wherein the curable acrylate resin comprises a pentaerthyitol triacrylate, a pentaerythritol tetraacrylate, a ethoxylated trimethylolpropane triacrylate, and combinations thereof.

18. The 2-component acrylate according to claim 14, wherein at least one of the first halochromic dye and the second halochromic dye is at least one of Cresol Red, Erichrome Black T, Thymol Blue, Bromothymol Blue, and combinations thereof.

19. The method according to item 10, wherein the difference in color has a ΔH of at least 1 when calculated in L*C*h color space.

20. The method according to item 10, wherein the difference in color has a ΔE of at least 1 when calculated in L*a*b* color space.
